(19) United States
(12) Patent Application Publication
(10) Pub. No.: US 2006/0217941 A1
(43) Pub. Date: Sep. 28, 2006

(54) APPARATUS, SYSTEM, AND METHOD FOR AUTOMATED CONSTRUCTION LAYOUT

(76) Inventor: Ron Soteros, Reno, NV (US)

Correspondence Address: KUNZLER & ASSOCIATES, 8 EAST BROADWAY, SUITE 600, SALT LAKE CITY, UT, 84111, US

(21) Appl. No.: 11/277,312

(22) Filed: Mar. 23, 2006

Related U.S. Application Data
(60) Provisional application No. 60/664,871, filed on Mar. 24, 2005.

(51) Int. Cl. G06F 17/50

(52) U.S. Cl. 703/1; 700/97

(57) ABSTRACT

An apparatus, system, and method are disclosed for the automatic arrangement of a construction layout. A menu module communicates a component menu to a user containing component types and component characteristics. An input module receives a user component type selection and a user component characteristic selection from the component menu. A calculation module automatically calculates a dimension associated with a construction layout that includes the selected user component type having the selected component characteristic. Beneficially, such an apparatus, system, and method simplify the construction layout process, such that the measurement, placement, and alignment of construction materials can be performed more efficiently than current construction layout tools allow.

### BACKGROUND OF THE INVENTION

1. Field of the Invention

This invention relates to construction layout and more particularly relates to automated construction layout and layout ribbon creation.

2. Description of the Related Art

Construction layout, including the measurement, placement, and alignment of building materials, affects all aspects of the construction process, and is often confusing and difficult. Beginning with the laying of the foundation and on through the framing, roofing, plumbing, and wiring process, the precise alignment of structural openings, studs, trusses, pipes, wires, and other structural members is integral to the proper completion of the building, and to its structural integrity. Even the proper spacing of posts and rails in a deck or fence can be mandated by building codes and will add to the aesthetic value of the structure being built.

Because most construction layout is done by hand, including the measurements and the layout marks, not only is the layout often imprecise, but it can also be confusing. Multiple layout marks that are in close proximity to each other, layout marks that are added or changed later, and layout marks that overlap or conflict with each other can be difficult to interpret. Many aspects of construction layout also involve multiple subcontractors or crews, for instance the framers, plumbers, and the electricians, but there is often little communication between these groups, resulting in lost time, work, and quality.

Other construction layout methods exist, but have limitations. Layout templates with commonly used measurements are available, but they are not customizable, and require extensive reference to building plans. Limited automated methods for construction layout also exist, but they still require the same manual measurement calculations that layout by hand requires, retaining much of the traditional complexity of construction layout by hand.

From the foregoing discussion, it should be apparent that a need exists for an apparatus, system, and method that automates construction layout. Beneficially, such an apparatus, system, and method would automatically arrange a construction layout and calculate dimensions related to the layout.

### SUMMARY OF THE INVENTION

The present invention has been developed in response to the present state of the art, and in particular, in response to the problems and needs in the art that have not yet been fully solved by currently available construction layout tools. Accordingly, the present invention has been developed to provide an apparatus, system, and method for automated construction layout that overcome many or all of the above-discussed shortcomings in the art.

The apparatus to automatically arrange a construction layout is provided with a plurality of modules configured to functionally execute the necessary steps of construction layout. These modules in the described embodiments include a menu module configured to communicate a component menu to a user, the component menu comprising a predefined component type field of a list of component types and a predefined component characteristic field of a substantially exhaustive list of component characteristics; an input module coupled to the menu module, the input module configured to receive a first user input selection of a component type via the component type field and to receive a second user input selection of a component characteristic via the component characteristic field; and a calculation module coupled to the input module, the calculation module configured to automatically calculate a dimension associated with a construction layout inclusive of a first component defined by the selected component type having the selected component characteristic.

The apparatus, in one embodiment, further comprises a display module coupled to the calculation module, the display module configured to show a construction view of the construction layout, including the first component. In one embodiment the display module further comprises a zoom module, the zoom module configured to adjust the magnification of the construction view.

In another embodiment, the apparatus may further comprise a spacing module coupled to the calculation module. The spacing module may be configured to calculate a spacing offset between the first component and a second component of the construction layout.

The apparatus further comprises, in one embodiment, a size module coupled to the calculation module. The size module may be configured to calculate a dimension of the first component.

The apparatus, in one embodiment, further comprises a print module coupled to the calculation module, the print module configured to print a layout template on a layout ribbon. The layout ribbon may have a print surface to receive the printed layout template and an opposing surface that may be coupled to a guide component within the construction layout.

In another embodiment, the apparatus may further comprise a translation module coupled to the print module. The translation module may be configured to facilitate printing a bilingual translation of the layout template on the layout ribbon.

The apparatus further comprises, in one embodiment, a library module coupled to the menu module. The library module may be configured to store and access a plurality of predefined component characteristics for a predefined component type.

The apparatus, in one embodiment, further comprises a placement module coupled to the calculation module. The placement module may be configured to locate the first component within the construction layout according to the calculated dimension.

In another embodiment, the apparatus may further comprise a material module coupled to the calculation module. The material module may be configured to communicate a material list to a user, the material list defining substantially all component types and quantities within the construction layout.

The apparatus further comprises, in one embodiment, an alert module coupled to the input module. The alert module may be configured to alert the user upon entry of an invalid user selection.

A system of the present invention is also presented to facilitate construction layout. The system may be embodied by a layout apparatus configured to automatically calculate a dimension of a construction layout based on a user input; a user interface to receive the user input; and a printer to print a representation of the dimension on a layout ribbon. The layout ribbon may comprise a ribbon having a print face and an opposing face; and a layout template printed on the print face of the ribbon, the layout template having an indicator to indicate a calculated location of a component relative to a guide component.

In particular, the system, in one embodiment, includes a display configured to display the user interface. In another embodiment, the system further comprises data storage to store and access a plurality of predefined component characteristics for a predefined set of component types.

In one embodiment, the layout ribbon included in the system may further comprise one or more description tags printed on the print face of the ribbon. The description tags may identify information related to the construction layout. In another embodiment the user interface receives the user input from a computer-aided design program.

A method of the present invention is also presented to arrange a construction layout. The method in the disclosed embodiments substantially includes the steps necessary to carry out the functions presented above with respect to the operation of the described apparatus and system. In one embodiment, the method includes communicating a component menu to a user, the component menu comprising a predefined component type field of a list of component types and a predefined component characteristic field of a substantially exhaustive list of component characteristics; receiving input from the user based on the component menu defining a component type and one or more component characteristics; and calculating one or more dimensions associated with a construction layout inclusive of a first component defined by the selected component type having the selected one or more component characteristics.

In a further embodiment, the method includes printing a layout template on a layout ribbon, the layout ribbon having a print surface to receive the printed layout template and an opposing surface that may be coupled to a guide component within the construction layout. The method may also include placing the first component within the construction layout according to the calculated dimension.

In another embodiment, the method includes communicating a material list to the user. The material list may define substantially all component types and quantities within the construction layout.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a construction layout system;

FIG. 2 is a schematic block diagram illustrating one embodiment of a layout apparatus;

FIG. 3 is a schematic diagram in elevation view illustrating one embodiment of a construction layout in the form of a stud wall;

FIG. 4 is a schematic block diagram illustrating one embodiment of a user interface display;

FIG. 5 is a schematic block diagram illustrating one embodiment of a layout ribbon;

FIG. 6 is a schematic diagram in perspective view illustrating one embodiment of a layout ribbon coupled to a guide component of a construction layout;

FIG. 7 is a schematic flow chart diagram illustrating one embodiment of a user layout method;

FIG. 8 is a screen shot illustrating one embodiment of a menu interface; and

FIG. 9 is a screen shot illustrating one embodiment of a user interface display.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

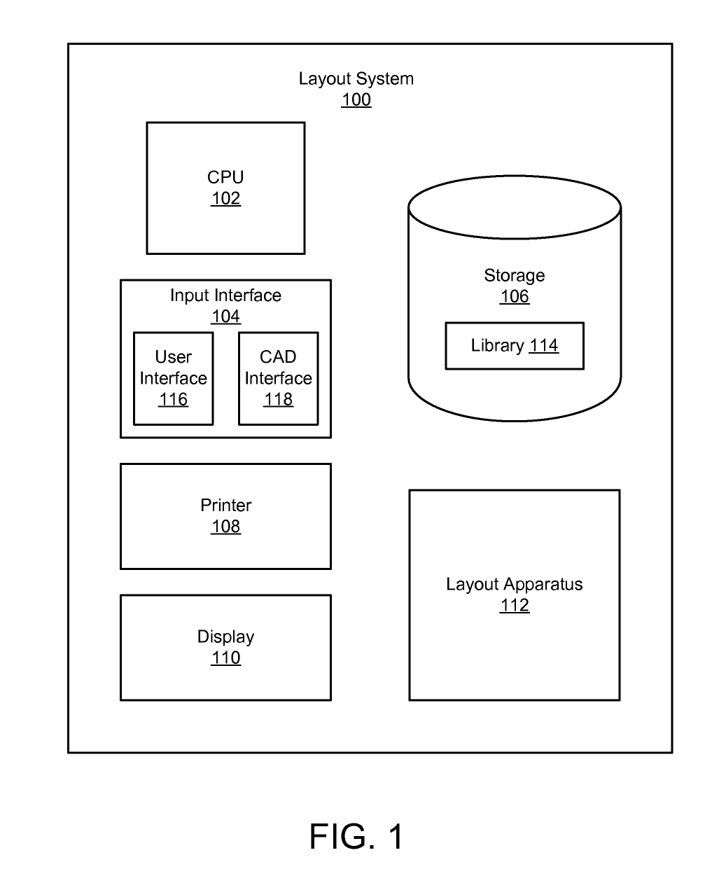

FIG. 1 depicts one embodiment of a construction layout system 100. The illustrated construction layout system 100 includes a central processing unit (CPU) 102, a user interface 104, and an electronic storage device 106. The illustrated layout system 100 also includes a printer 108, a display 110, and a layout apparatus 112.

The CPU 102 processes arithmetic and logical operations, as well as control instructions. In one embodiment, the input interface 104 includes hardware and software to facilitate the receipt of user commands and data into the layout system 100. In one embodiment, the input interface 104 receives data from a user utilizing the user interface 116, and in another embodiment the input interface 104 receives data from the computer-aided design (CAD) interface 118. In one embodiment the CAD interface 118 may interface with and receive data from any computer program or data file for use by the layout system 100.In this manner, the layout system 100 may create a construction layout based on a construction design or building plan created by any system, user, computer software, or computer hardware that can be accessed using the input interface 104.

In another embodiment the printer 108 communicates information in printed format from the layout system 100 to the user. Similarly, the display 110 displays graphical images or other representations from the layout system 100 to the user. Collectively, the input interface 104, printer 108, and display 110 may include hardware, such as keyboards, visual displays, and the like, and software, such as a command prompt, a graphical user interface (GUI), menus, and the like.

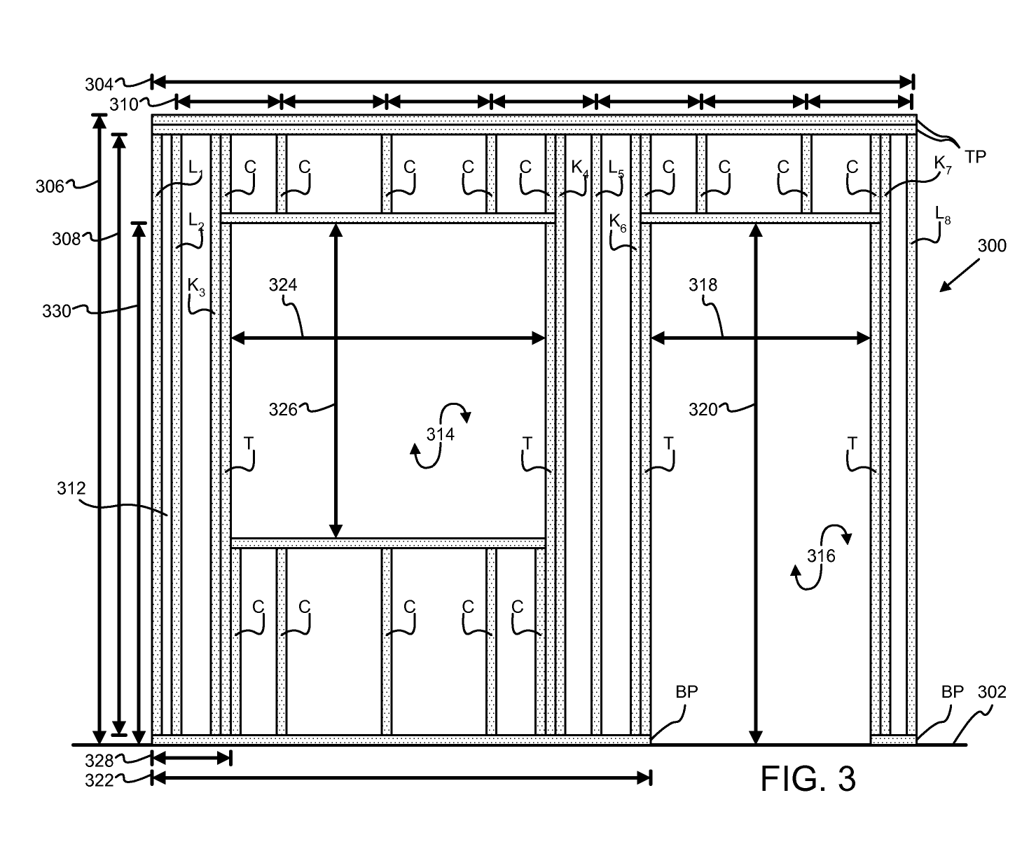

In one embodiment, the electronic storage device 106 stores data in magnetic or electronic format. In particular, the electronic storage device 106 may store a library 114 that includes data for a number of construction components. As used herein, a “construction component” is any component that may be used in a construction layout. A “construction layout” is a combination of multiple components arranged and oriented in a manner to build something. For example, a wall in a house may be represented by a construction layout. The wall may include a base plate, a top plate, layout studs, king studs, trimmers, cripples, and other similar components. Other types of construction layouts may include any system of components that are arranged to build something, such as a house or other structure. One example of a construction layout is represented and described in more detail with reference to FIG. 3.

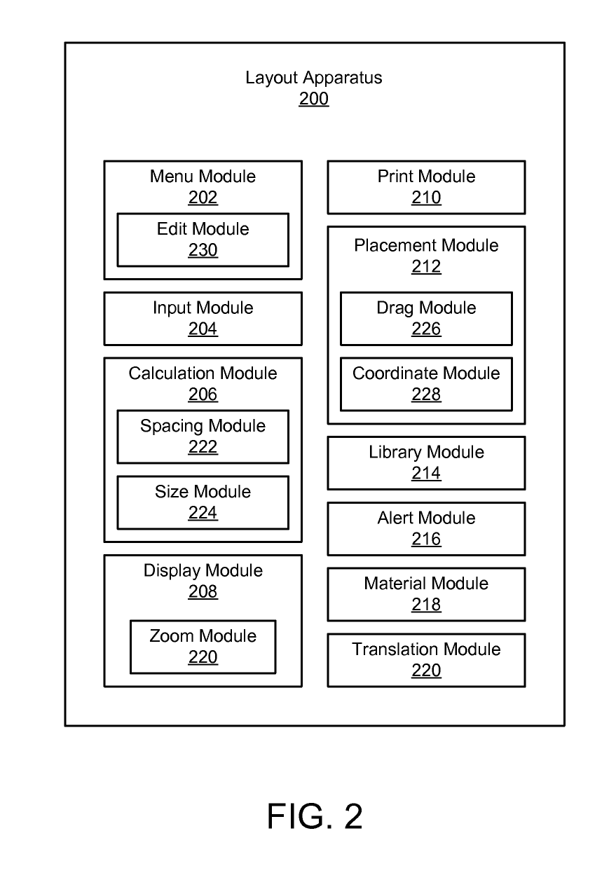

The layout apparatus 112 facilitates automated arrangement of a construction layout. Advantageously, embodiments of the layout apparatus 112 facilitate dimensioning individual components, as well as arranging one or more components with respect to other components within the construction layout. In particular, the layout apparatus 112 facilitates arranging multiple components with respect to one or more guide components, which may be used as a reference for locating other components within the construction layout. One example of a layout apparatus 112 is shown and described in more detail with reference to FIG. 2.

FIG. 2 depicts one embodiment of a layout apparatus 200 that is substantially similar to the layout apparatus 112 of FIG. 1. The illustrated layout apparatus 200 includes a menu module 202, an input module 204, and a calculation module 206. The illustrated layout apparatus 200 also includes a display module 208, a print module 210, a placement module 212, a library module 214, an alert module 216, a material module 218, and a translation module 220. In one embodiment, a zoom module 220 may be coupled to the display module 208. In another embodiment, a spacing module 222 and a size module 224 may be coupled to the calculation module 206. In another embodiment, a drag module 226 and a coordinate module 228 may be coupled to the placement module 212.

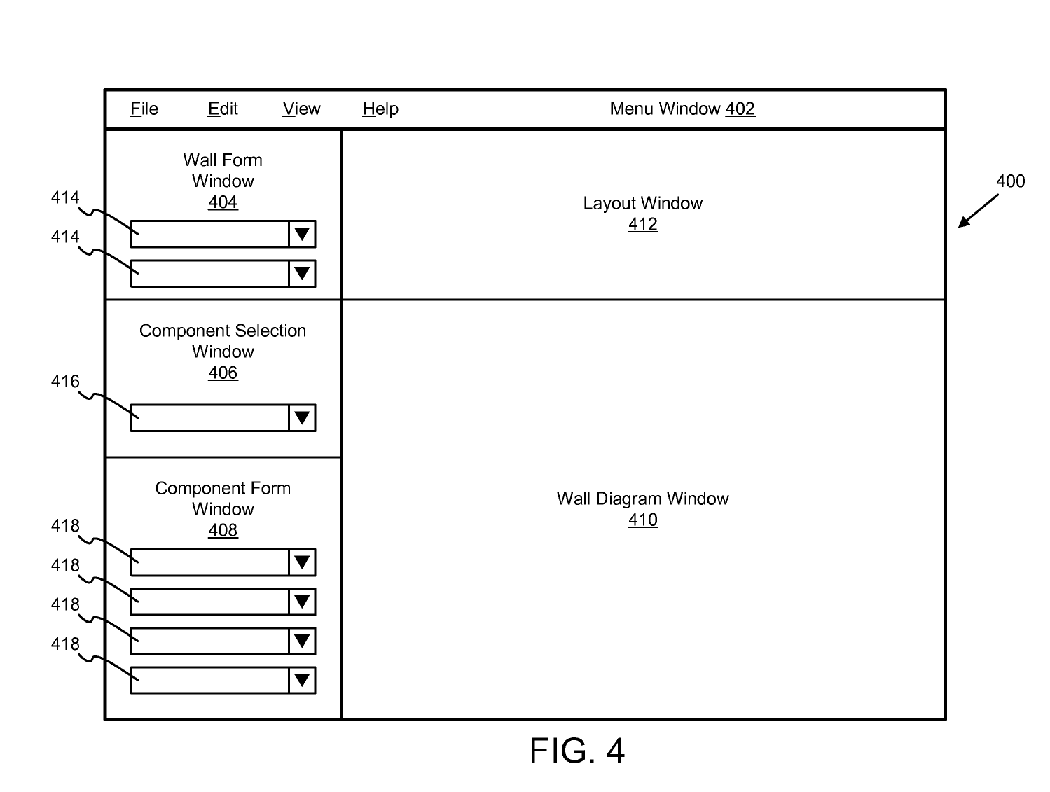

In one embodiment, the menu module 202 communicates a menu, such as a component menu, to a user. The component menu may include a predefined component type field and a predefined component characteristic field. In one embodiment, the predefined component type field includes list of component types. One example of a component type field is depicted and described in more detail with reference to FIG. 4. Similarly, the predefined component characteristic field may include a substantially exhaustive list of component characteristics for a specified component type. One example of a component characteristic field is depicted and described in more detail with reference to FIG. 4.

The menu module 202 may employ various types of menu technologies, including check boxes, pull-down selection menus, text entry boxes, and so forth. In certain embodiments, the type of menus employed by the menu module 202 may depend at least in part on the type of construction layout, component, and so forth. In another embodiment the menu module 202 may employ the edit module 230 to edit various aspects of the construction layout. In one embodiment, the edit module 230 may change layout dimensions or component types. In another embodiment, the edit module 230 may add, delete, cut, copy, or paste components or groups of components. In a further embodiment, the edit module 230 may perform any other editing function.

In one embodiment, the input module 204 receives user input selections corresponding to the menus established by the menu module 202. In particular, the input module 204 may receive a first user input selection of a component type via the component type field. Similarly, the input module 204 may receive a second user input selection of a component characteristic via the component characteristic field. Additionally, the input module 204 may receive other types of user input, including operational program commands, other menu selections, and so forth. In one embodiment the input module 204 may receive user input from a computer program or data file.

In one embodiment, the calculation module 206 automatically calculates a dimension associated with a construction layout that includes a component defined by the user input. The dimension may be a spacing dimension between two components or may be a physical dimension corresponding to a selected component. In one embodiment, the calculation module 206 may employ the spacing module 222 to calculate a spacing offset dimension between to construction components. Alternatively, the calculation module 206 may employ the size module 224 to calculate a physical dimension of a single component.

In one embodiment, the display module 208 shows a construction view of the construction layout to a user. In particular, the display module 208 may show a graphical representation of the construction layout and all of the construction components to the user via the display 110. In other embodiments, the display module 208 also may display other perspectives or content to the user, including components, menus, printouts, and so forth. In one embodiment the zoom module 220 is coupled to the display module 208. The zoom module 220 may, in one embodiment, alter the magnification of the graphical representation displayed, increasing or decreasing the magnification level. In another embodiment the zoom module 220 may also navigate to various locations in or views of the graphical representation displayed. One example of a user interface display is shown and described in more detail with reference to FIG. 4.

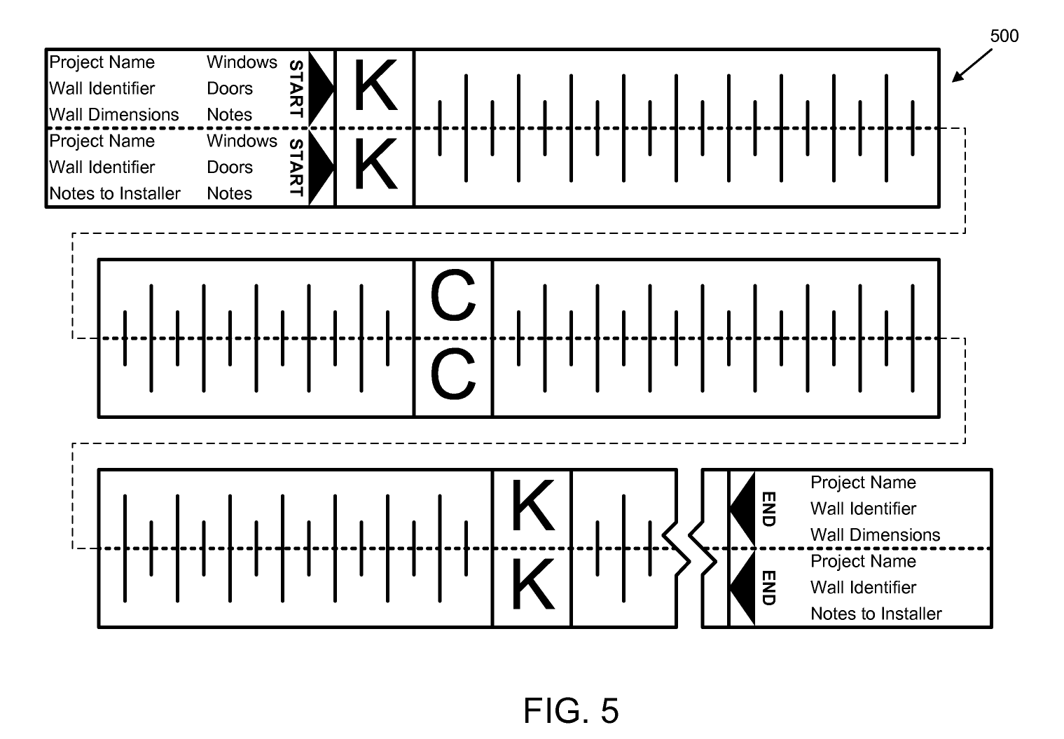

In one embodiment, the print module 210 prints a layout template on a layout ribbon according to some or all of the dimension calculations performed by the calculation module 206. One example of a layout ribbon is shown and described in more detail with reference to FIG. 5. In further embodiments, the print module 210 also may facilitate printing other content, such as the construction view of the construction layout, the dimensions of a construction component, a materials list, or other content related to the construction layout.

In one embodiment, the placement module 212 locates a component within the construction layout according to the calculated dimension. In another embodiment, the placement module 212 also may facilitate the addition of further construction components to a construction layout. For example, in one embodiment, the placement module 212 may employ the drag module 226 to allow a user to select a component, drag the component to a desired location, and drop the component in approximately the desired location. In other words, the drag module 226 may facilitate drag-and-drop placement of components within a construction layout.

Alternatively, the placement module 212 may employ the coordinate module 228 to allow a user to add a component to a construction layout in response to entry of selected coordinates of the desired location. For example, a user may locate a component at a position corresponding to an x horizontal coordinate and a y vertical coordinate.

In one embodiment, the library module 214 stores and accesses a plurality of predefined component characteristics for a predefined component type within the library 114. Such a library 114 may be particularly useful where a component defines several subcomponents. For example, a window component within a rough-in framing construction layout may define a height of the window, a rough-in width of the window opening, a rough-in height of the window opening, and so forth, corresponding to a particular window model number or standardized window size. In another embodiment, the library module 214 also facilitates updates and customization of the library 114.

In one embodiment, the alert module 216 alerts the user upon entry of an invalid user selection. The validity of a user selection may be determined by building code requirements, physical impossibility, inconsistent dimensions, deletion of a critical component, unintelligible text, or another standard for determining input validity.

In one embodiment, the material module 218 communicates a material list for the construction layout to the user. The material list may define some or all of the components types and quantities within the construction layout. Furthermore, the material list may define the sizes of each of the components. In one embodiment, the material list also may be customizable to show only certain desired components.

In one embodiment, the translation module 220 facilitates printing a bilingual translation of the layout template. Additionally, the translation module 220 may facilitate displaying bilingual information to the user via the display module 208 and display 110.

FIG. 3 depicts one embodiment of a construction layout 300 in the form of a non-load-bearing stud wall. Other types of construction layouts may include any construction layout that might benefit from a template ribbon, including installation of shingles, installation of siding, installation of decks and railings, installation of rough plumbing, installation of drywall, and installation of most other equipment in both commercial and residential buildings. Furthermore, other types construction layouts may include construction projects in other fields or industries in which layout planning may be beneficial.

The illustrated construction layout 300 is shown in elevation perspective on a building surface 302, such as a floor. The construction layout 300 is defined by a length 304 and a height 306. In another embodiment, the construction layout also may be defined by a depth. The wall includes a baseplate “BP” and two top plates “TP” separated by a plurality of layout studs “L.” Each of the layout studs “L” has a height 308. In the illustrated embodiment, the layout studs “L” are offset at a spacing offset distance 310. For example, the layout studs “L” may be arranged at 16 inches on center, leaving a typical physical space of approximately 14.5 inches between the facing edges of the layout studs “L.”

However, due to other building requirements, additional layout studs “L” or other components may be added to the construction layout at intermediate locations. Sometimes these additional components alter or replace some of the original layout studs “L.” Where a portion of an original layout stud remains above a door or above or below a window, the remaining portion is referred to as a cripple “C.” Alternatively, these additional components may be in addition to the original layout studs “L.” Either way, the addition of windows, doors, and components for other similar structures makes the construction layout more difficult to plan using conventional technologies and, therefore, subject to error.

In the illustrated embodiment, the layout studs “L₂,” “L₅,” and “L₈” and the cripples “C” are offset approximately 16″ on center with respect to each other. The layout stud “L₁” is offset from the layout stud “L₂” to form a channel 312, which allows another framing wall to intersect with the depicted wall in a substantially perpendicular manner (with respect to the plane of the illustration). The king studs “K₃” and “K₄” are added for a window rough-in opening 314. Likewise, the king studs “K₆” and “K₇” are added for a door rough-in opening 316. The trimmers “T” are also added for the window and door rough-in openings 314, 316, in addition to some horizontal framing members.

The illustrated door rough-in opening 316 is defined by a door width 318 and a door height 320. The horizontal location of the door rough-in opening 316 may be defined by a door offset 322 that is measured with respect to a starting side of the wall (in this case, the layout stud “L₁”). Similarly, the window rough-in opening 314 is defined by a window width 324 and a window height 326. The horizontal location of the window rough-in opening 314 may be defined by a window offset 328 with respect to the starting side of the wall. Additionally, the vertical location of the window rough-in opening 314 may be described by a rough-in height 330 (which is depicted the same as the height 320 of the door rough-in opening 316, but may be different).

FIG. 4 depicts one embodiment of a user interface display 400. The user interface display 400 may be displayed by the display module 208 on the display 110 of the layout system 100 or on another similar display device. The illustrated user interface display 400 implements a variety of windows, including a menu window 402, a wall form window 404, a component selection window 406, and a component form window 408. The illustrated user interface display 400 also includes a wall diagram window 410 and a layout window 412. In another embodiment, the user interface display 400 may use fewer or more windows, may use floating palates, or may use other technologies to display information to the user.

In one embodiment, the menu window 402 displays typical program selection items, as well as program-specific operation items. One example of the selections available via the menu window 402 is provided in Table 1.

TABLE 1
Exemplary Menu Selections.

| File | | Edit | | View | | Help | |
|---|---|---|---|---|---|---|---|
| 1. | New | 1. | Undo | 1. | View Current | 1. | Help files |
| 2. | Open | 2. | Cut | | Wall | | and FAQ's |
| 3. | Close | 3. | Copy | 2. | Full screen | | |
| 4. | Save | 4. | Paste | 3. | Zoom In | | |
| 5. | Save As | 5. | Select All | 4. | Zoom Out | | |
| 6. | Import | 6. | Delete | | | | |
| 7. | Page Set | | Selection | | | | |
| | Up | 7. | Ad | | | | |
| 8. | Print | | Structural | | | | |
| | Elevation | | Support | | | | |
| 9. | Print Tape | | | | | | |
| 10. | Print | | | | | | |
| | Selection | | | | | | |

In one embodiment, the wall form window 404 may allow a user to select one of several standard wall configurations. Alternatively, the wall form window 404 may allow a user to select a previously created construction layout that may be modified. Additionally, the wall form window 404 may display the overall characteristics of the selected wall, including height, length, stud spacing, and so forth. The wall form window 404 may allow a user to make selections via one or more selection fields 414, which may include pull-down menus, button, check boxes, text boxes, and so forth. One example of user selections that may be available via the wall form window 404 is provided in Table 2.

TABLE 2
Exemplary Wall Form Selections

| 1. | Do you want to design an: (check boxes) | |
|---|---|---|
| | Interior Wall | |
| | Exterior Wall | |
| 2. | Do you want to design from the: (check boxes) | |
| | Left | |
| | Right | |
| 3. | Do you want to design a: (check boxes) | |
| | Rectangular Wall | |
| | Angled Wall | |
| 4. | Do you want to design a Shear wall Yes No | |
| | a. | If yes: Wall thickness |
| | b. | Nailing Schedule - × |
| | c. | Nail Size - |
| | d. | Change Bottom Plate × |
| | e. | Change stud size every 48″ or double studs to center, |
| | | every 48″ (check one - change parameter blocking) |
| 5. | Wall Size - Dropdown menu (may be check boxes): | |
| | a. | 2″ × 4″ (call out dimension) |
| | b. | 2″ × 6″ (call out dimension) |
| | c. | 2″ × 8″ (call out dimension) |
| | d. | Custom Size - ″ × ″ (Nominal dimension) |
| 6. | Wall Length and Height (user only allowed one selection here): | |
| | a. | (check box) Rectangular Wall |
| | | a. ′ ″ × ′ ″ (Nominal dimension) |
| | b. | (check box) Angled Wall |
| | | a. Length ′ ″ |
| | | b. Highest Height ′ ″ |
| | | c. Lowest Height ′ ″ |
| 7. | Stud Spacing: On Center To Center (check boxes) | |
| | a. | 16″ (Pull-down Menu) |
| | b. | 24″ |
| | c. | Custom |
| 8. | Anchor Bolt spacing: On Center To Center (check boxes) | |
| | a. | 16″ (Pull-down Menu) |
| | b. | 24″ |
| | c. | Custom |
| 9. | Hold Downs: On Center To Center (check boxes) | |
| | a. | 16″ (Pull-down Menu) |
| | b. | 24″ |
| | c. | Custom |
| 10. | Header Height - ′ ″ (nominal dimension) | |
| | a. | Header Dimensions |
| | | a. ′ × ″ nominal or |
| | | b. ′ × ″ callout dimensions |
| | b. | Number of Trimmers (user enters single number) |
| | c. | Plates: |
| | | a. Bottom Framing Plates (single number) |
| | | b. Top framing Plates (single number) |
| | | c. Top Plates (single number) |

In one embodiment, the component selection window 406 allows a user to select a standard or customized component that is either within the construction layout or to be added to the construction layout. The user may use a pull-down selection menu 416 or other type of menu to select the desire component. Alternatively, the user may double-click or otherwise select a component from the construction layout displayed in the wall diagram window 410.

In one embodiment, the component form window 408 displays or allows a user to select certain characteristics of the selected component. Some of the characteristics that may be displayed or selected include physical dimension of the component, location of the component within the construction layout, and so forth. The component form window 408 may employ pull-down menus 418 or other selection devices or display technologies.

In certain embodiments, the component form window 408 may allow a user to select or display information regarding a component that includes several subcomponents. For example, the window rough-in opening 314 of FIG. 3 may be considered a component and king studs “K₃” and “K₄” and corresponding trimmers “T” and header may be considered sub-components. In that case the window rough-in opening 314 may be considered a definable component having several definable subcomponents. Other types of components for a wall may include, but are not limited to, channels, hold downs, anchors, doors, and so forth.

In one embodiment, the wall diagram window 410 displays a construction view of the construction layout. For example, if the construction layout is the wall 300 of FIG. 3 then the wall 300 may be displayed in the wall diagram window 410. The wall diagram window 410 also may display dimensions or other characteristics of either the construction layout or the individual components. Further embodiments of the wall diagram window 410 also may include rulers, legends, selection palates, and other tools to select, view, and manipulate the construction layout.

In one embodiment, the layout window 412 displays a view of the layout template for the construction layout. The size of the displayed layout template may correspond to the size of the displayed construction layout, the physical size of the layout ribbon, or a magnified view of the layout template.

Another embodiment of the user interface display 400 may include an alert window (not shown) that displays an alert to a user when the user enters invalid information or when a conflict arises in the construction layout. Another embodiment of the user interface display 400 may include tabular views of other information, such as a materials list, a wood cut list, a budgeting list, or other information related to the construction layout.

FIG. 5 depicts one embodiment of a layout ribbon 500. The illustrated layout ribbon includes a starting description tag, a layout portion, and an ending description tag. The description tags may identify information related to the construction layout, including the project name, a wall identifier, the wall dimensions, the number of windows, the number of doors, notes, or any other information related to the construction layout. The layout portion is attached to a guide component of the construction layout to aid in the assembly of the construction layout. A guide portion may be any component of the construction layout that is used as a reference for other components. In certain embodiments, a construction layout may have multiple guide components. For example, a wall similar to the wall 300 shown in FIG. 3 may have two guide component, such as the lower top plate “TP” and the bottom plate “BP.”

The dimensions of the layout ribbon 500 may vary depending on the type of guide component(s) to which the layout ribbon 500 may be attached. In one embodiment, where the guide component is a two-by-four framing member, the length of the guide portion of the layout ribbon 500 is approximately equal to the length of the guide component. Similarly, the width of the layout ribbon 500 may be approximately equal to the width of the guide component.

In another embodiment, the width of the layout ribbon 500 may be approximately equal to the width of multiple guide components. For example, in assembling a wall such as the wall 300 of FIG. 3, a top plate “TP” and bottom plate “BP” may be placed next to one another and the layout ribbon 500 may be attached to both plates at approximately the same time. The layout ribbon 500 then may be separate along the length of the layout ribbon 500 so that the top plate “TP” and bottom plate “BP” may be moved apart and arranged with the layout studs between the plates. In one embodiment, the layout ribbon 500 may have a longitudinal perforation along the center of the layout ribbon 500 running the length of the layout ribbon 500. Alternatively, an installer may simply cut the layout ribbon with a utility knife, for example, after the layout ribbon 500 has been attached to the plates.

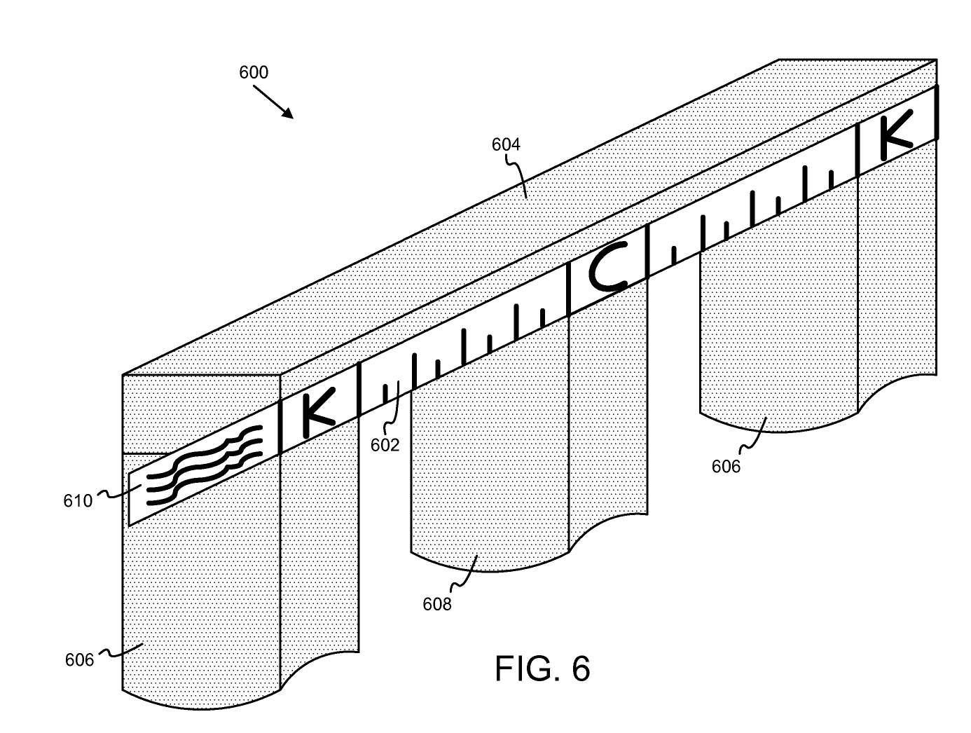

FIG. 6 depicts one embodiment of a construction layout 600 having a layout ribbon 602 coupled to a guide component 604. The layout ribbon 602 is substantially similar to one half of the layout ribbon 500 of FIG. 5. The layout ribbon 602 may be attached to the guide component 604 (in this case, a top plate “TP”) by any number of coupling methods, including, but not limited to, nails, staples, adhesive, tension, clips, and so forth.

Although the layout ribbon 602 is shown having a width less than the width of the guide component 604 the width of the layout ribbon 602 may be less than or greater than the illustrated width. The illustrated layout ribbon 602 includes measurement hash marks at predetermined distances. The layout ribbon 602 also includes stud location indicators “K” and “C” for the calculated location of two king studs 606 and a cripple 608, respectively. The layout ribbon also includes a starting description tag 610 that may or may not be attached to a portion of the guide component 604.

In further embodiments, the layout ribbon 602 may include other symbols or information to aid in the proper assembly of the construction layout. In particular, the layout ribbon 602 may include dimension callouts for the various components indicated by the layout ribbon 602. Additionally, the layout ribbon 602 may include color-coding of the marks or symbols.

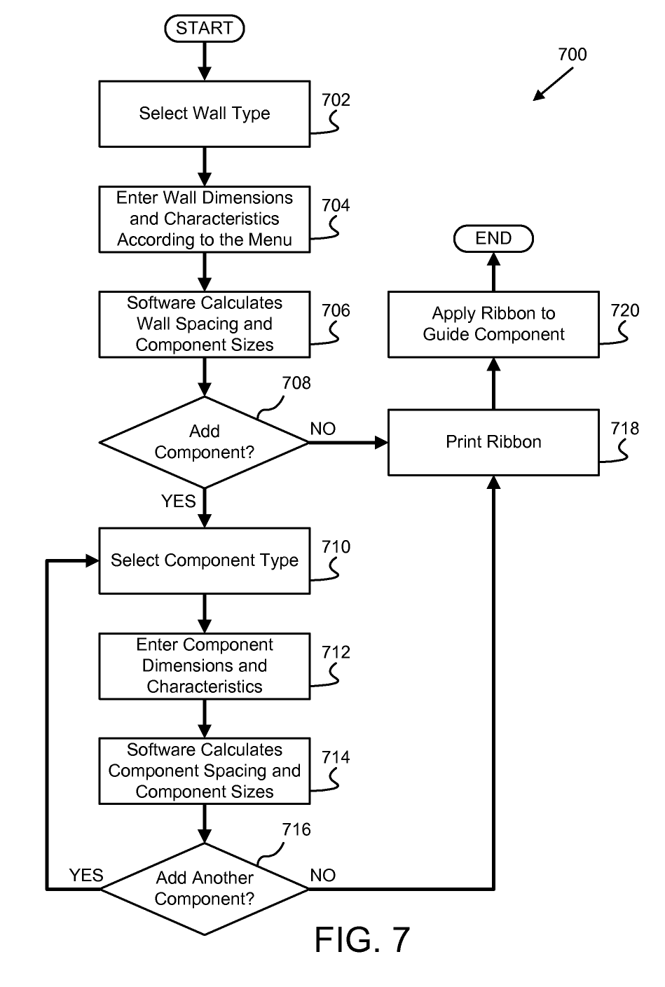

FIG. 7 depicts one embodiment of a user layout method 700 that may be employed in conjunction with the layout apparatus 200 of FIG. 2. Although the user layout method 700 is described with exemplary reference to a construction layout in the form of a wall, the user layout method 700 may be applied as illustrated or in a modified form to facilitate automated arrangement of many different types of construction layouts.

The illustrated user layout method 700 begins and a user selects 702 a wall type. In one embodiment, the user employs the input module 204 to select a wall type via the menu selections in the wall form window 404. The user then enters 704 wall dimensions and characteristics for the selected wall. In one embodiment, the user employs the input module 204 to input the wall characteristics. Note that in one embodiment the user input is entered through a computer program or a data file, either of which may be accessed using the CAD interface 118.

After the user selects the wall type and characteristics, the layout apparatus 200 then calculates 706 the construction layout, including dimensions of the individual components as well as the spacing between components. The display module 208 also may display a representation of the construction layout. At this point, the construction layout may include a top plate “TP,” a bottom plate “BP,” and a number of layout studs “L” substantially evenly spaced according to a specified spacing offset, such as 16 or 24 inches.

In one embodiment, the menu module 202 then determines 708 if the user wants to add another component to the construction layout. For example, the menu module 202 may request that the user respond to a menu selection request. If the user decides to add a component, the user selects 710 a component type and enters 712 the component dimensions and characteristics. In another embodiment, if the user is a computer program or a data file, all component types, dimensions, and characteristics may be accessed in one step. Additionally, the calculation module 206 may calculate 714 any of the characteristics of the component if the desired insertion location is known. The calculation module 206 also calculates 714 the spacing offset between the added component and any adjacent components. In one embodiment, the calculation module 206 may further determine if the spacing offset dimensions are within a certain tolerance and adjust the original or additional components accordingly.

The menu module 202 then determines 716 if the user wants to add any more components to the construction layout. If so, the illustrated user layout method 700 iteratively returns to allow the user to select 710 another component type and repeat the operations described above. After all of the components have been added, or if no components are added, the print module 210 then prints 718 the layout template on the layout ribbon. The user may then apply 720 the print ribbon to one or more guide components. The depicted user layout method 700 then ends.

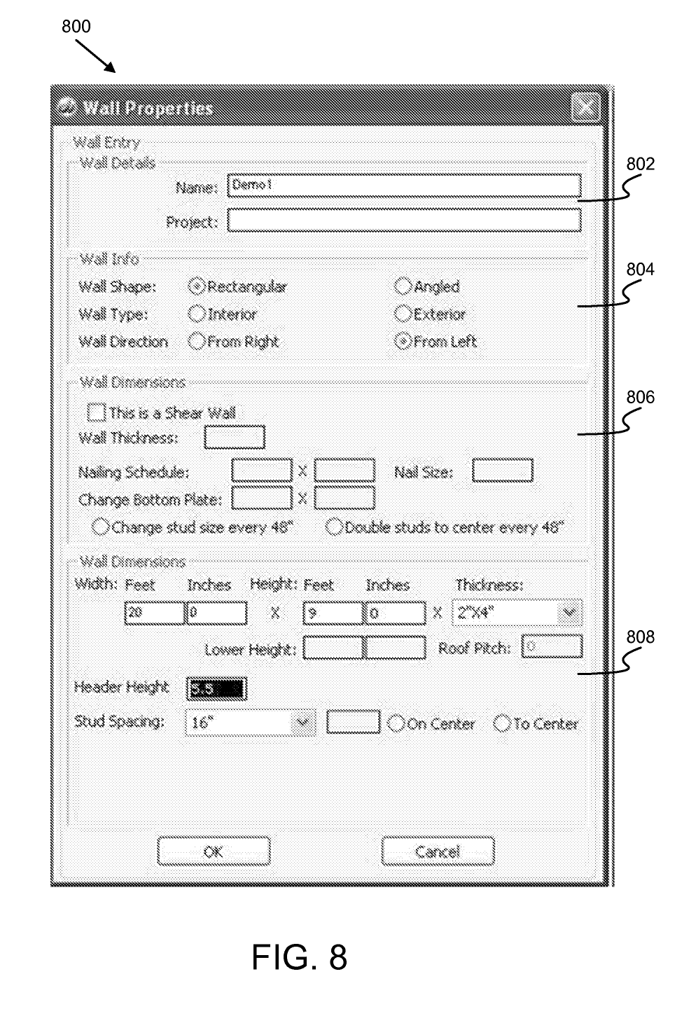

FIG. 8 depicts one embodiment of a menu interface 800. In certain embodiments, the menu interface 800 may be substantially similar to one or more of the wall form window 404, component selection window 406, component form window 408 of FIG. 4. In particular, the illustrated menu interface 800 includes a wall detail input section 802, a wall info input section 804, a first wall dimensions input section 806, and a second wall dimensions input section 808. Although certain menu types and content are shown in each of these input sections 802-808, other types of menu types, user selection, and content may be included in or excluded from each of these input sections 802-808.

The wall detail input section 802 allows a user to identify the wall and the project. The wall info input section 804 allows a user to identify the wall shape, type, and direction. The first wall dimensions input section 806 allows a user to indicate if the wall is a shear wall. Additionally, the first wall dimensions input section 806 may allow a user to identify some of the dimensions of the wall, as well as a nailing schedule for the wall. The second wall dimensions input section 808 allows a user to identify some additional dimensions of the wall, as well as stud spacing of the wall.

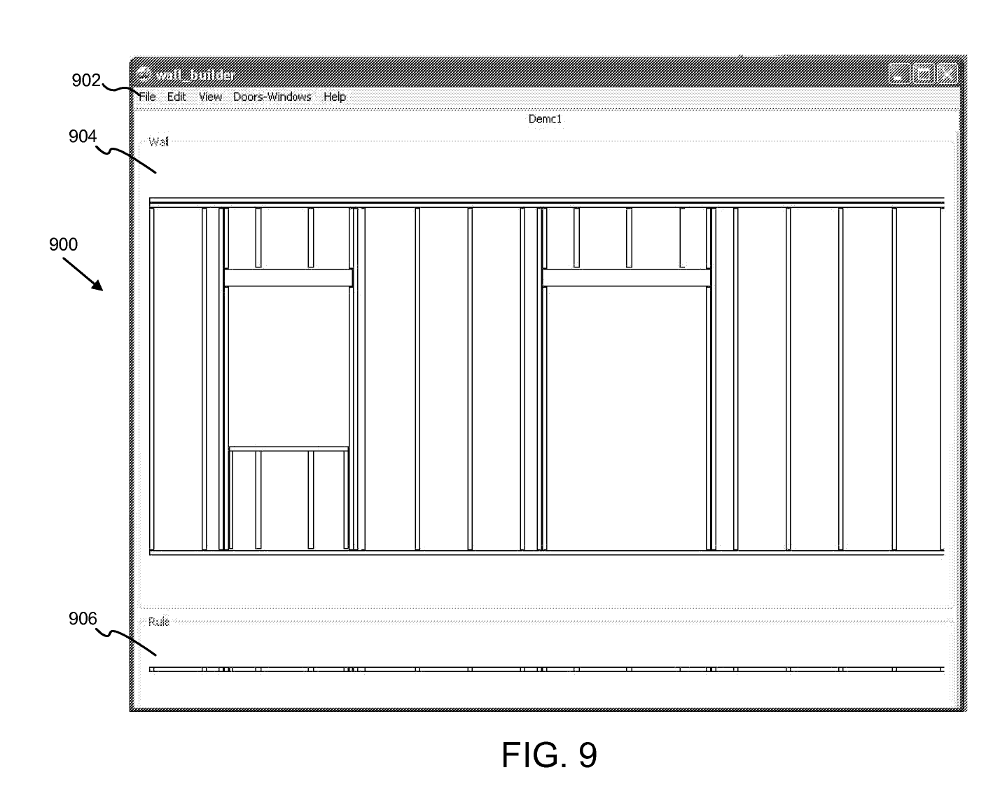

FIG. 9 depicts one embodiment of a user interface display 900. In certain embodiments, the user interface display may be substantially similar to one or more of the menu window 402, wall diagram window 410, and layout window 412 of FIG. 4. In particular, the illustrated user interface display 900 includes a menu window 902 a wall window 904, and a rule window 906. Although certain windows and content are shown in FIG. 9, other types of windows and content may be included in the user interface display 900.

In one embodiment, the menu window 902 allows a user to select menu options to design a construction layout 300 or to operate the program and manipulate the user interface display 900. The wall window 904 displays a representation of the construction layout 300. The rule window 906 displays a representation of the layout template 500 for the construction layout 300.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to automatically arrange a construction layout, the apparatus: comprising:
a menu module configured to communicate a component menu to a user, the component menu comprising a predefined component type field of a list of component types and a predefined component characteristic field of a substantially exhaustive list of component characteristics;
an input module coupled to the menu module, the input module configured to receive a first user input selection of a component type via the component type field and to receive a second user input selection of a component characteristic via the component characteristic field; and
a calculation module coupled to the input module, the calculation module configured to automatically calculate a dimension associated with a construction layout inclusive of a first component defined by the selected component type having the selected component characteristic.

2. The apparatus of claim 1, further comprising a display module coupled to the calculation module, the display module configured to show a construction view of the construction layout, including the first component.

3. The apparatus of claim 2, wherein the display module further comprises a zoom module, the zoom module configured to adjust the magnification of the construction view.

4. The apparatus of claim 1, further comprising a spacing module coupled to the calculation module, the spacing module configured to calculate a spacing offset between the first component and a second component of the construction layout.

5. The apparatus of claim 1, further comprising a size module coupled to the calculation module, the size module configured to calculate a dimension of the first component.

6. The apparatus of claim 1, further comprising a print module coupled to the calculation module, the print module configured to print a layout template on a layout ribbon, the layout ribbon having a print surface to receive the printed layout template and an opposing surface that may be coupled to a guide component within the construction layout.

7. The apparatus of claim 6, further comprising a translation module coupled to the print module, the translation module configured to facilitate printing a bilingual translation of the layout template on the layout ribbon.

8. The apparatus of claim 1, further comprising a library module coupled to the menu module, the library module configured to store and access a plurality of predefined component characteristics for a predefined component type.

9. The apparatus of claim 1, further comprising a placement module coupled to the calculation module, the placement module configured to locate the first component within the construction layout according to the calculated dimension.

10. The apparatus of claim 1, further comprising a material module coupled to the calculation module, the material module configured to communicate a material list to a user, the material list defining substantially all component types and quantities within the construction layout.

11. The apparatus of claim 1, further comprising an alert module coupled to the input module, the alert module configured to alert the user upon entry of an invalid user selection.

12. A system to facilitate a construction layout, the system comprising:
a layout apparatus configured to automatically calculate a dimension of a construction layout based on a user input;
a user interface to receive the user input; and
a printer to print a representation of the dimension on a layout ribbon, wherein the layout ribbon comprises:
a ribbon having a print face and an opposing face; and
a layout template printed on the print face of the ribbon, the layout template having an indicator to indicate a calculated location of a component relative to a guide component.

13. The system of claim 12, further comprising a display configured to display the user interface.

14. The system of claim 12, further comprising data storage to store and access a plurality of predefined component characteristics for a predefined set of component types.

15. The system of claim 12, the layout ribbon further comprising one or more description tags printed on the print face of the ribbon, the description tags identifying information related to the construction layout.

16. The system of claim 12, wherein the user interface receives the user input from a computer-aided design program.

17. A computer readable medium tangibly embodying a program of machine-readable instructions executable by a digital processing apparatus to perform an operation to arrange a construction layout, the operation comprising:
communicating a component menu to a user, the component menu comprising a predefined component type field of a list of component types and a predefined component characteristic field of a substantially exhaustive list of component characteristics;
receiving input from the user based on the component menu defining a component type and one or more component characteristics; and
calculating one or more dimensions associated with a construction layout inclusive of a first component defined by the selected component type having the selected one or more component characteristics.

18. The computer readable medium of claim 17, wherein the instructions further comprise an operation to print a layout template on a layout ribbon, the layout ribbon having a print surface to receive the printed layout template and an opposing surface that may be coupled to a guide component within the construction layout.

19. The computer readable medium of claim 17, wherein the instructions further comprise an operation to place the first component within the construction layout according to the calculated dimension.

20. The computer readable medium of claim 17, wherein the instructions further comprise an operation to communicate a material list to the user, the material list defining substantially all component types and quantities within the construction layout.
